(19) United States
(12) Patent Application Publication
(10) Pub. No.: US 2008/0081490 A1
(43) Pub. Date: Apr. 3, 2008

(54) Ball grid array socket and method of making the same

(75) Inventor: Fu-Pin Hsieh, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/906,452

(22) Filed: Oct. 1, 2007

(30) Foreign Application Priority Data
Sep. 29, 2006 (CN) 200610096227.6

(51) Int. Cl. H01R 12/00

(52) U.S. Cl. 439/71

(57) ABSTRACT

A BGA socket (100) includes an insulative housing (20) defining a grid array of contact cavities (23) in a bottom face (22); a plurality of electrical contacts (30), each electrical contact having a solder ball at one end, said electrical contacts disposed in said grid array of contact cavities with said solder balls exposed out of the contact cavities from the bottom face; and an insulative standoff (40) mounted on the bottom face of the insulative housing, said insulative standoff defining a plurality of contact holes (41) extending through therein, said solder balls received in said contact holes.

### BACKGROUND OF THE INVENTION

1. Field of the Invention

The present invention relates to a Ball Grid Array (BGA) socket, and more particularly, relates to a BGA socket having standoff for mounting on a printed circuit board.

2. Description of the Prior Art

A BGA socket 9 related to present invention is disclosed in FIG. 1. The BGA socket 9 includes an insulative housing 8 and a grid array of conductive contacts 7 received in the insulative housing 8. The insulative housing 8 defines a mounting face 81 and a connecting face 82 mutually opposite to each other. A solder ball is set up at one end of each conductive contact 7 on the mounting face 82. The insulative housing 8 forms a number of standing ribs 821 along edges of the mounting face 82.

However, there are some faults for the BGA socket 9: the first, since the contacts of BGA socket 9 are usually arrayed in high density and there is no divider between any two adjacent solder balls, there is high chance of bridging between adjacent solder balls; the second, when the BGA socket 9 is mounted onto a printed circuit board, a center portion of the insulative housing 8 may be distorted toward the printed circuit board, which makes the conductive contacts 7 offset in right positions, and even more, damages the conductive contacts 7; the third, the standing ribs 821 improve the chance of the solder balls interfering with the insulative housing 8.

### BRIEF SUMMARY OF THE INVENTION

Therefore, one object of the present invention is to provide a BGA socket decreasing the chance of bridging between adjacent solder balls.

A second object of the present invention is to provide a BGA socket having structure helping to keep the conductive contacts in the right position and so protect the conductive contact from being damaged.

Still another object of the present invention is to provide a BGA socket decreasing the chance of the solder balls interfering with the insulative housing 8.

A BGA socket according to the present invention comprises an insulative housing defining a grid array of contact cavities in a bottom face; a plurality of electrical contacts received in the contact cavities; and an insulative standoff mounted on a bottom face of the insulative housing. Each of said electrical contacts has a solder ball at one end and exposing out of the contact cavities from the bottom. The insulative standoff forms a plurality of standing walls supporting the bottom face of insulative housing. The plurality of standing walls further define a plurality of contact holes extending therethrough for receiving the solder balls therein.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a BGA socket related to the present invention;

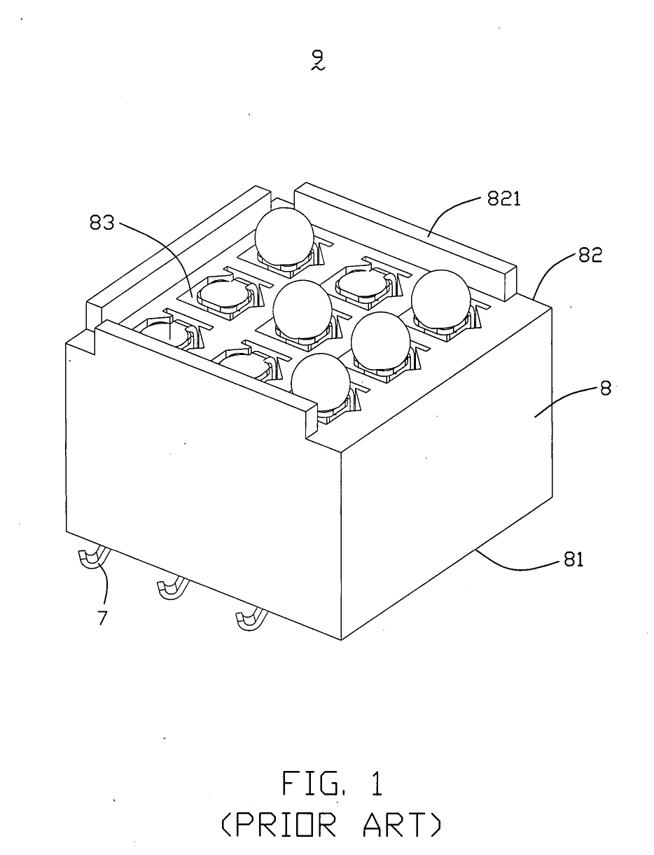

FIG. 2 is a perspective view of a BGA socket embodying the present invention;

FIG. 3 is another perspective view of the BGA socket of FIG. 2 with an insulative standoff removed aside in a different visual angle;

FIG. 4 is a perspective view of a conductive contacts of the BGA socket shown in FIGS. 2 and 3; and

FIG. 5 is another perspective view of the BGA socket of FIG. 2 in a different visual angle.

### DETAILED DESCRIPTION OF THE INVENTION

Reference will now be made to the drawing figures to describe the present invention in detail.

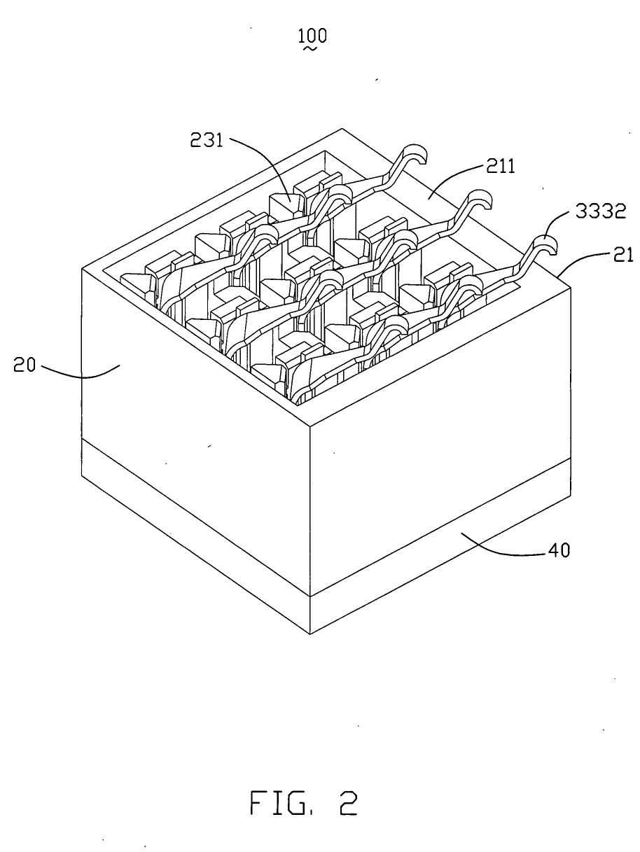

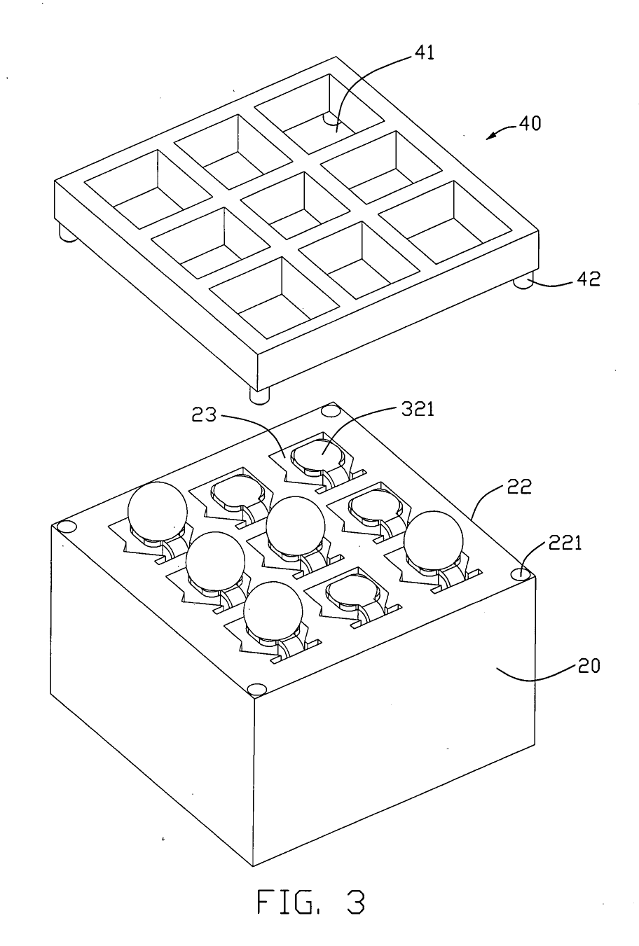

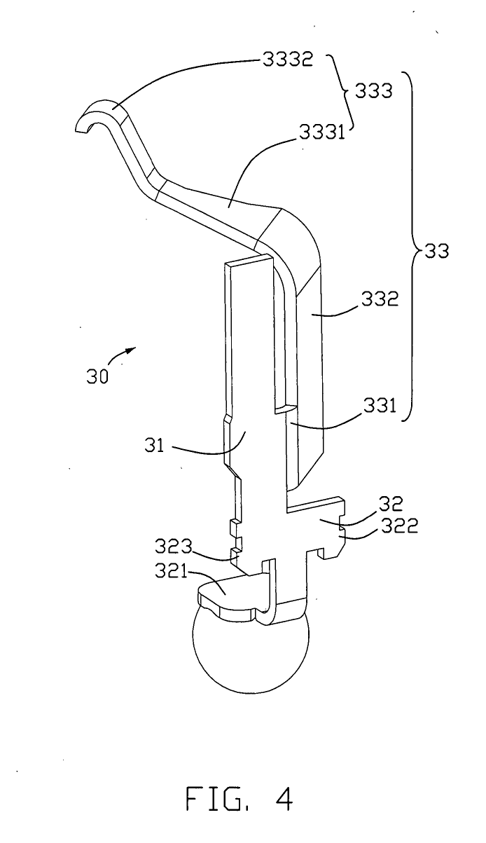

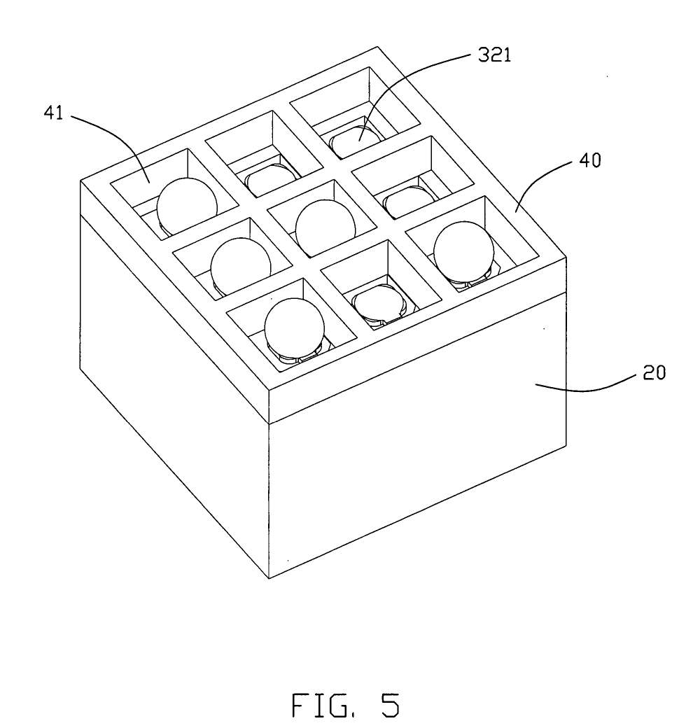

The BGA socket of the present invention is used for connecting a chipset to a printed circuit board. According to an embodiment of the present invention shown in FIGS. 2-5, the BGA socket 100 includes an insulative housing 20, a plurality of conductive contacts 30 received in the insulative housing 20 and an insulative standoff 40 mounted onto the insulative housing 20.

The insulative housing 20 is shaped in a rectangular board and defines a bottom face 22 and a loading face 21 mutually opposite to each other. A plurality of contact cavities 23 array in a center portion of the bottom face 22 and extend to the loading face 21. A plurality of protrusions 231 extend between the contacts cavities 23 from the loading face 21 along a first length and edge walls 211 extending from the loading face 21 along a second length longer than the first length and surrounding the protrusions 231. The insulative housing 20 further defines four securing holes 221 at comers of the insulative housing 20 in the bottom face 22.

Each of the conductive contacts 30 comprises a base portion 31, a securing portion 32 extending downwardly from the base portion 31, a tail portion 321 bent perpendicularly from an end of the securing portion 32 and a spring arm 33 bent from a side of the base portion 31. The securing portion 32 forms a first stab 322 and a second stab 323. The spring arm 33 includes connecting portion 331, supporting portion 332 and spring portion 333. The spring portion 333 further includes an extending portion 3331 and a contacting portion 3332.

The insulative standoff 40 has a similar profile like the insulative housing 20 and defines a grid array of contact holes 41 corresponding to the contact cavities 23 of the insulative housing 20. The insulative standoff 40 forms four securing posts 42 at corners for interfering mating into the securing holes 221 of the insulative housing 20.

Method of assembling the BGA socket 100 includes of the following steps: providing the insulative housing 20; providing the plurality of electrical contacts 30, and inserting the plurality of electrical contacts 30 respectively in the contact cavities 23 of the insulative housing 20 with the tail portion 321 aligned on the bottom face; setting up a solder ball on the tail portion 321 of each electrical contact 30, when said solder balls are exposed out of the contact cavities 23 from the bottom face 22; and mounting the insulative standoff 40 on the bottom face 22 of the insulative housing 20, the insulative standoff 40 defining a plurality of contact holes 41 extending through therein, when the solder balls is received in said contact holes 41, and the securing posts 42 of the insulative standoff 40 interfering mate into corresponding securing holes 221 of the insulative housing 20.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

We claim:

1. A BGA socket comprising:
an insulative housing defining a grid array of contact cavities in a bottom face;
a plurality of electrical contacts, each electrical contact having a solder ball at one end, said electrical contacts disposed in said grid array of contact cavities with said solder balls exposed out of the contact cavities from the bottom face; and
an insulative standoff mounted on the bottom face of the insulative housing.

2. The BGA socket according to claim 1, wherein said insulative standoff forms a plurality of standing walls supporting the bottom face of insulative housing, said plurality of standing walls defining a plurality of contact holes extending therethrough, said solder balls received in said contact holes.

3. The BGA socket according to claim 2, wherein the insulative standoff has a vertical height extending from the bottom face to a mounting face to stand on a printed circuit board, said vertical height being no higher than a vertical height of the solder balls.

4. The BGA socket according to claim 2, wherein the insulative housing and the insulative standoff form securing devices mating with each other for fixing the insulative standoff to the insulative housing.

5. The BGA socket according to claim 4, wherein the insulative housing and the insulative standoff are shaped in rectangular boards and the securing devices are disposed at corners of the rectangular boards.

6. The BGA socket according to claim 4, wherein the securing devices of the insulative housing include securing holes and the securing devices of the insulative standoff include securing posts interference mated into said securing holes.

7. The BGA socket according to claim 6, wherein the insulative housing defines a loading face opposite to the bottom face for loading a chipset thereon, a plurality of protrusions extending from said loading face.

8. A method for making a BGA socket comprising the following steps:
providing an insulative housing having a grid array of contact cavities in a bottom face;
providing a plurality of electrical contacts and inserting said plurality of electrical contacts respectively in said contact cavities;
setting up a solder ball at one end of each electrical contact with said solder balls exposed out of the contact cavities from the bottom face; and
providing an insulative standoff and mounting the insulative standoff on the bottom face of the insulative housing.

9. The method according to claim 8, wherein the insulative standoff forms a plurality of standing walls supporting the bottom face of insulative housing, said plurality of standing walls defining a plurality of contact holes extending therethrough, said solder balls received in said contact holes.

10. A BGA (Ball Grid Array) socket comprising:
an insulative housing defining a grid array of contact receiving cavities in a bottom face;
a plurality of electrical contacts, each electrical contact having a solder ball at one end, said electrical contacts disposed in said grid array of contact cavities with said solder balls exposed out of the contact cavities from the bottom face; and
an insulative standoff discrete from and located below the bottom face of the insulative housing.

11. The BGA socket as claimed in claim 10, wherein said standoff defines therein a plurality of through openings in vertical alignment with the corresponding contact receiving cavities, respectively.

12. The BGA socket as claimed in claim 10, wherein said standoff is assembled to the housing directly.
